(19) United States
(12) Patent Application Publication
(10) Pub. No.: US 2002/0011192 A1
(43) Pub. Date: Jan. 31, 2002

(54) Moisture conditioning building material and its production method

(76) Inventors: Yuji Tachizuka, Kitakyushu-shi (JP); Hiroo Inoue, Kitakyushu-shi (JP); Kouzou Hanada, Kitakyushu-shi (JP)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 09/851,835

(22) Filed: May 9, 2001

(30) Foreign Application Priority Data
May 9, 2000 (JP) 135282/2000
Feb. 28, 2001 (JP) 55157/2001

(51) Int. Cl. C04B 7/14; B32B 13/00

(52) U.S. Cl. 106/765; 428/332

(57) ABSTRACT

Moisture conditioning building material is compound of diatomite, which contains 5%˜30% by weight in the range of grain size 2 micrometer˜100 micrometer, inorganic material and either or both of organic reinforcing fiber and inorganic fiber, and is obtained by depositing method.

Moisture conditioning building material has superb moisture absorbing/releasing characteristic, fire proofing, fire resistance, machinability, dimensional stability, nailing characteristic, and is light-weighted.

### BACKGROUND OF THE INVENTION

This invention relates to moisture conditioning building material and its production method which has a material performance to absorb and release moisture and is applicable as materials for ceiling, interior, exterior, and floor.

### RELATED ART

Heretofore, in case of housing construction in Japan, a construction style with interior that applied clay wall construction as well as wood and processed wood building materials had been adopted from long ago. Houses structured this way had excellent function to forestall condensation and extreme dehydration in the residence space by the ability to absorb and release moisture of clay wall and wood building materials.

Whereas, it has been difficult to obtain high-quality wood resources in recent years caused by the decrease in wood resources and its price is rising steadily. In one hand, wood building materials defects that they are flammable materials and are easily rotten by pests such as termites.

On the other hand, clay wall construction is also rarely employed because there are extremely less skilled workers with high craftsmanship and because of rise in labor charges.

In recent years, as a result of pursuing to have high airproof and high heat insulation oriented houses, water generated in a room cannot diffuse outside and cause dew condensation all over the room, cause wetness and stain, and cause problems with ticks and mold. To solve this problem, provision of board building material superior in absorbing/releasing moisture is strongly wanted.

### DISCLOSURE OF INVENTION

This invention is objected to provide moisture conditioning building material which is superior in moisture absorbing/releasing characteristic, fire proofing, fire resistance, machinability, dimensional stability, nailing (fixture) characteristic, and is light weight.

To solve the above-mentioned problems, the invention as described in claim 1 provides moisture conditioning building material compound of diatomite, which contains 5%˜30% by weight in the range of grain size 2 micrometer˜100 micrometer, inorganic material and either or both of organic reinforcing fiber and inorganic fiber.

The invention as described in claim 2 is the moisture conditioning building material as claimed in claim 1, characterized in that the inorganic material is one or combination of gysum: which gives the inorganic material fire proofing, fire resistance, form stability, form formation by depositing-curing-drying, aqua-hardening substance such as slag cement: which gives machinability, nailing (fixture) characteristic, hardness, and formability, and perlite: which gives light weight by its bulkiness.

The invention as described in claim 3 is the moisture conditioning building material as claimed in claim 2, characterized in that it is comprised of dihydrate gypsum: 2%˜30% (by weight), aqua-hardening substance: 15%˜60%, perlite: 5%˜15%, either or both of organic reinforcing fiber: 3%˜/5% and inorganic fiber: 1%˜8%, and also characterized in that it is obtained by depositing method.

The invention as described in claim 4 is the moisture conditioning building material as claimed in claim 2. characterized in that it is comprised of cement: 30%˜50% (by weight), perlite: 5%˜20%, inorganic mixture of materials: 10%˜30%, either or both of organic reinforcing fiber: 3%˜13% and inorganic fiber: 4%˜8%, and also characterized in that it is obtained by depositing method.

The invention as described in claim 5 is the moisture conditioning building material as claimed in claim 2, characterized in that it is comprised of dihydrate gypsum: 20%˜50% (by weight), slag: 20%˜50%, inorganic admixture: 5%˜15%, organic reinforcing fiber: 3%˜5%, inorganic fiber: 4%˜8%, and also characterized in that it is obtained by depositing method.

The invention as described in claim 6 is the moisture conditioning building material as claimed in claim 2, characterized in that it is comprised of asbestos: 10%˜30% (by weight), cement: 30%˜70%, inorganic admixture: 8˜12%, organic reinforcing fiber: 3%˜5%, and also characterized in that it is obtained by depositing method.

The invention as described in claim 7 is the moisture conditioning building material as claimed in claim 2, characterized in that it is comprised of asbestos: 2%˜6% (by weight), slag: 20%˜40%, gypsum: 20%˜60%, either or both of organic reinforcing fiber: 3%˜5% and inorganic fiber: 1%˜3%, and also characterized in that it is obtained by depositing method.

The invention as described in claim 8 is the moisture conditioning building material as claimed in claim 2, characterized in that it is comprised of lime: 15%˜50% (by weight), silica rock: 15%˜50%, either or both of organic reinforcing fiber: 3%˜5% and inorganic fiber: 1%˜8%, and also characterized in that it is obtained by depositing method.

The second aspect of this invention provides a method to produce moisture conditioning building material compound of diatomite, which contains 5%˜80% by weight in the range of grain size 2 micrometer˜100 micrometer, inorganic material and either or both of organic reinforcing fiber and inorganic fiber, in the board formation of 4˜20 mm in thickness.

The invention as described in claim 10 is the production method for moisture conditioning building material as claimed in claim 9, characterized in that water is added to the materials to make mixed slurry, then deposit to make a board in the thickness as prescribed, cure and dry it.

### BRIEF DESCRIPTION OF THE DRAWING

FIG. 1 is a schematic view to outline the structure of round net depositing machine.

### THE BEST MODE OF THE INVENTION

The following is the description in response to preferred embodiment of the present invention related to moisture conditioning building material and its production method.

The moisture conditioning building material according to the present invention comprises diatomite, which contains 5%˜80% by weight in the range of grain size 2 micrometer˜100 micrometer, inorganic material and either or both of organic reinforcing fiber and inorganic fiber, and is formed in the plate like board of 4˜20 mm in thickness. Since the invention is constituted as above, moisture conditioning building material that is superb in moisture absorbing/releasing characteristic, fire proofing, fire resistance, nailing fixture characteristic, and light weight is provided. Although this moisture conditioning building material could be produced using extrusion molding or batch type molding method, it is mainly explained about the production method by depositing which can produce uniform quality of building material that does not have uneven density, and which does not cause bleeding of powder slurry (sedimentation of solid constituent, dissolution, isolation of admixture) in the production process. In other words, the building material comprises diatomite, which contains 5%˜30% by weight in the range of grain size 2 micrometer˜100 micrometer, and either or both of organic reinforcing fiber and inorganic fiber as the essential constituents. This intention of moisture conditioning building material is obtained through the process of combining these essential constitutes with aquahardening substance such as cement and slag, light-weight aggregate such as perlite, as inorganic materials, of adding water to make slurry, of depositing to obtain a plate like board, and of steam curing and of drying the board.

(Embodiment 1)

This embodiment is the moisture conditioning building material which has constituents described in the claim 3. The below is the explanation about the constituents of moisture conditioning building material of this embodiment.

Gypsum has advantages of having fire proofing and fire resistance, small expansion/contraction in change of temperature, easiness of curing and molding. It had been used as fire proof member or retardant and fire resistant material from long time ago. However, gypsum by itself has weakness in primary physical properties, especially in bending strength and screw nail retention capability or fixture characteristic. In this invention, this weakness is supplemented by addition of aqua-hardening substance. Gypsum is 2%˜30% added by weight. Gypsum has proved effective to proceed curing or hardening when aqua-hardening substance such as slag and cement is hydrated. When the addition is less than 2%, it is difficult to develop effect of addition. On the other hand, when the addition is more than 30%, aqua-hardening substance such as slag and cement diminishes its strength bestow capability, water proof property, hardening property, and formability. Moreover, it depreciates the primary physical properties, especially bending strength and screw nail retention property or fixture characteristic.

Aqua-hardening substance such as slag and cement, when compounded, makes it easy to produce moisture conditioning building material by enhancing strength thereof through matrix adhering stiffness, and by giving characteristics such as curing and molding easily and at a low cost. Moreover, aqua-hardening substances have water proofing property other than fire proofing and fire resistance. In this embodiment, addition is done in the range of 15%˜60%. When the addition is less than 15%, it is difficult to develop strength bestow capability, water proofing property, hardening property; and formability. On the other hand, when the addition is more than 60%, it creates an increase in the weight of moisture conditioning building material, and cracks due to dryness or shrinkage.

Diatomite is added to provide moisture absorbing/releasing ability to the moisture conditioning building material. In this embodiment, it is added in the range of 5%˜30%. When the addition is less than 5%, it cannot provide moisture conditioning building material with the desired moisture absorbing/releasing ability. On the other hand, when the addition is more than 80%, it depreciates primary physical properties, especially bending strength and screw nail retentivity of the moisture conditioning building material.

In this invention, the grain size range of diatomite is specified to 2 micrometer˜100 micrometer. When the grain size is smaller than 2 micrometer, it cannot provide moisture absorbing/releasing ability. On the other hand, when the grain size is bigger than 100 micrometer, diatomite grains separate and cannot make uniform mat and spoils outer appearance when slurry is taken up. Ordinarily, it is implemented in the grain size ≦70 micrometer. The preferred grain size of the diatomite is 10 micrometer˜50 micrometer.

In this invention, the substance that provides moisture absorbing/releasing ability to the moisture conditioning building material other than diatomite could be silica gel or zeolite in the specified range of grain size.

Perlite is added to enhance fire resistance and to save weight of the moisture conditioning building material as light-weight aggregate. In this embodiment, it is added in the range of 5%˜15%. When the addition is less than 5%, it is too small to contribute to the moisture conditioning building material's improvement of fire resistance and weight saving. On the other hand, when addition is more than 15%, it fails the moisture conditioning building materials balance between moisture absorbing/releasing characteristic and primary physical properties.

As the organic reinforcing fiber to improve the strength of moisture conditioning building material, add pulp for example. In this embodiment, it is added in the range of 3%˜5%. When the addition is less than 3%. it cannot provide moisture conditioning building material with the strength and improvement effect of workability. On the other hand, when the addition is more than 5%, the pulp loses moisture conditioning building material's characteristic as an incombustible (inflammable) material because it is organic material. As an organic reinforcing fiber, vinylon can be used other than pulp.

Inorganic fiber such as fiberglass and rock wool are added, for the same purpose as organic reinforcing fiber, to improve the strength of moisture conditioning building material and improve effect of workability. In this embodiment, it is added in the range of 1%˜8%. When the addition is less than 1%, it is too small to contribute to improvement of strength. And when the addition is more than 8%, it obstructs the kneading operation of materials and water, and also fiber agglomerated substance called “balls” are mixed and spoils the uniformity of moisture conditioning building materials quality. In this embodiment, either or both of organic reinforcing fiber and inorganic fiber is added.

In this invention, other than these constituents, it is possible to add calcium carbonate, mica, and calcium hydroxide as additional materials in range of 0%˜0.5%, 1%˜8%, 1%˜1.5% respectively.

(Embodiment 2)

This embodiment is the moisture conditioning building material which has constituents described in the claim 4. In this embodiment, cement 30%˜50% (by weight) as aqua-hardening substance is mixed. Aqua-hardening substance is mixed to enhance the strength of the moisture conditioning building material. From this point of view, mixing at least 30% is necessary. On the other hand, when the addition is more than 50%, it creates an increase in the weight of moisture conditioning building material and cracks due to dryness or shrinkage.

In this embodiment, inorganic fiber is 4%˜8% by weight. As inorganic fiber, fiberglass, rock wool, asbestos can be used. When the addition is less than 4%, it cannot develop reinforcing effect. On the other hand, when the addition is more than 8%, it obstructs the kneading operation of materials and water, and also fiber agglomerated substance called “balls” are mixed and spoils the uniformity of moisture conditioning building material's quality.

Perlite is added to enhance fire resistance and to save weight of the moisture conditioning building material as light-weight aggregate. In this embodiment, it is added in the range of 5%˜20%. When the addition is less than 5%, it is too small to contribute to the moisture conditioning building material's improvement of fire resistance and weight saving. On the other hand, when addition is more than 20%, it fails the moisture conditioning building materials balance between moisture absorbing/releasing characteristic and primary physical properties.

Inorganic admixture is added 10%˜30%. As inorganic admixture, slag powder, fly ash, serpentinite, and silica powder can be used. The amount of inorganic admixture, in relation to the amount of cement, is in the range of 104%˜30% considering that the CaO/SiO2 ratio is the suitable ratio. When it misses this range, it decreases the bending strength of the moisture conditioning building material.

In this embodiment, organic reinforcing fiber is added in the range of 3%˜13% in order to enhance the strength of moisture conditioning building material and improve depositing ability of slurry which is composed of materials and water. As the organic reinforcing fiber, pulp and vinylon fiber can be used. When the addition is less than 3%, it does not develop the effect of addition. And when the addition is more than 13%, the pulp loses the characteristic as moisture conditioning building material's incombustible material. In this embodiment, either or both of aforesaid inorganic fiber and this organic reinforcing fiber is added.

(Embodiment 3)

This embodiment is the moisture conditioning building material which has constituents described in the claim 5. In this embodiment, constituent other than the essential constituents such as dihydrate gypsum 20%˜50% by weight is mixed, Dihydrate gypsum is mixed in order to provide the moisture conditioning building material with the fire proofing and fire resistance. Dihydrate gypsum can provide curing and molding easily and at low cost, For such a purpose, at least 20% of dihydrate is mixed. However, when the addition is more than 50%, it depreciates primary physical properties, especially bending strength and screw nail retentivity.

As aqua-hardening substance, slag is mixed at least 20%. However, when the addition is more than 50%, it creates an increase in the weight of moisture conditioning building material and cracks due to dryness or shrinkage.

As filtering enhancement additive, inorganic admixture is mixed in the range of 5%˜15%. Silica and calcium carbonate can be used as inorganic admixture.

When the addition is less than 5%, it cannot develop depositing and molding enhancement effect. When the addition is more than 15%, absorption percentage of the moisture conditioning building material gets excessive and creates performance decrement.

Inorganic fiber such as fiberglass and rock wool are mixed 4%˜8% in order to enhance the strength and workability of the moisture conditioning building material with organic reinforcing fiber. When the addition is less than 4%, it cannot develop the effect of addition, and when the addition is more than 8%, it obstructs the kneading operation of materials and water, and also fiber agglomerated substance called “balls” are mixed and spoils the uniformity of moisture conditioning building material's quality.

Organic reinforcing fiber is mixed 3%˜6% in order to enhance the strength of the moisture conditioning building material. When the addition is less than 3%, it cannot develop the effect of strength enhancement, and when the addition is over 5%, the moisture conditioning building material loses its characteristic as an incombustible material. In this embodiment, either or both of 3%˜5% of organic reinforcing fiber and 4%˜8% of inorganic fiber are mixed.

(Embodiment 4)

This embodiment is the moisture conditioning building material which has constituents described in the claim 6.

In this embodiment, constituent other than the essential constituents such as asbestos: 10%˜30% by weight, cement: 30%˜70% are mixed. Asbestos enhances the strength of the moisture conditioning building material, as well as enhances the ability to deposit during the production process.

In other words, in addition to the fact that it has a superb characteristic as the reinforcing fiber of the inorganic matrix, it exerts tremendous effect to catch solid substances inside the slurry materials during the deposit and mold.

From such point of view, at least 10% of inorganic fiber is mixed. However, when the addition is more than 30%, it makes the depositing operation more difficult on the contrary.

As aqua-hardening substance, 30%˜70% cement is blended. At least 30% of cement is blended as the matrix molding constituent. However; when the addition is more than 70%, it creates an increase in the weight of moisture conditioning building material and cracks due to dryness or shrinkage.

In order to enhance strength of the moisture conditioning building material, 3%˜5% of organic reinforcing fiber is mixed. When the addition is less than 3%, it cannot develop the strength enhancement effect, and when the addition is more than 5%, it loses the moisture conditioning building material's characteristic as an incombustible material.

In this embodiment, 8%˜12% of inorganic admixture such as silica and calcium carbonate is mixed as filtering enhancement additive during the depositing process.

When the addition is less than 8%, it cannot develop depositing and molding enhancement effect. When the addition is more than 12%, absorption percentage of the moisture conditioning building material gets excessive and creates performance decrement.

(Embodiment 5)

This embodiment is the moisture conditioning building material which has constituents described in the claim 7. In this embodiment, constituent other than the essential constituents such as asbestos: 2%˜6%, slag: 20%˜40%, gypsum: 20%˜60% are mixed. When the addition of slag as aqua-hardening substance is less than 20%, it is difficult to develop strength ability, water proofing property, hardening property, and formability. On the other hand, when the addition is more than 40%, it creates an increase in the weight of moisture conditioning building material and cracks due to dryness or shrinkage.

Gypsum is blended with slag in order to provide fire proofing and fire resistance to the moisture conditioning building material. In this embodiment, at least 20% of gypsum is blended in order to develop fire proofing and fire resistance well. However, when the addition is more than 60%, it notably depreciates primary physical properties, especially bending strength and screw nail. With other inorganic fiber such as fiberglass and rock wool, 2% of asbestos is mixed to enhance the bending strength of the moisture conditioning building material, in addition, as inorganic material catching element such as cement during the production process. However, in this embodiment, the effect is saturated at 6%.

Inorganic fiber other than asbestos, such as fiberglass and rock wool are mixed in the range of 1%˜3% in order to enhances the bending strength of the moisture conditioning building material together with asbestos. When the addition is less than 1%, it cannot develop the effect of addition. When the addition is more than 3%, from the amount of additive with the amount of asbestos, obstructs the kneading operation of materials and water, and fiber agglomerated substance called “balls” are dispersed and spoils the uniformity of moisture conditioning building materials quality.

In order to enhance the strength of the moisture conditioning building material, 3%˜5% of organic reinforcing fiber is mixed.

When the addition is less than 3%, it cannot develop the strength enhancement effect. When the addition is more than 5%, it loses the moisture conditioning building material's characteristic as an incombustible material. In this embodiment, either or both of organic reinforcing fiber: 3%˜5% and inorganic fiber: 1%˜3% are mixed.

(Embodiment 6)

This embodiment is the moisture conditioning building material which has constituents described in the claim 8. In this embodiment, constituent other than the essential constituents such as lime: 15%˜50%, silica rock: 16%˜50%, either or both of organic reinforcing fiber: 3%˜5% and inorganic fiber: 1%˜8% are mixed.

Lime functions as CaO constituent and silica rock and diatomite function as SiO2 constituents. From the point of view called “molding of gelatinization composition of matter”, to avoid status of excess silicate of below 0.2 CaOl SiO2 or status of excess lime of over 3.0 CaOl SiO2. fundamental composition is lime: 15%˜50%, silica rock: 15%˜50%, and diatomite: 5%˜30%.

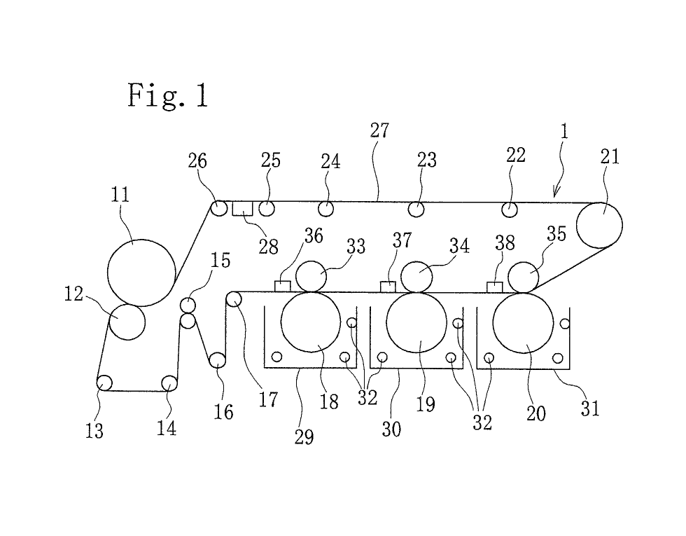

Next is an explanation about the production method of this invention, the moisture conditioning building material. In this invention, the moisture conditioning building material is produced by a depositing method using round net depositing machine. FIG. 1 indicates the conventional round net depositing machine.

As indicated in FIG. 1, the round net depositing machine that performs the depositing method as described below or Hatcheck method named after its inventor is structured that endless felt belt 27 is movably wound around making roll 11, bottom roll 12. first tension roll 13, warm roll 14, swing roll 15, stretch roll 16, second wire cylinder 20, return roll 21, first felt roll 22, second felt roll 23, third felt roll 24, fourth felt roll 25, and guide roll 26. Sanction box 28 is located in the vicinity of guide roll 26 and functions as to imbibe the material lamination on the endless felt belt 27.

First wire cylinder 18˜third wire cylinder 20 are located in first bath 29˜third bath 31, below them respectively. Inside each of first bath 29˜third bath 31, several agitator 32 are set up.

Endless felt belt 27 is adjacent to upper parts of first wire cylinder 18˜third wire cylinder 20 and each are wedged between first coach roll 33˜third coach roll 35. More-over, on the upper part of endless felt belt 27 above first bath 29˜third bath 31, first sanction box 36˜third sanction box 38 are located. These sanction boxes 36, 37, 38 function to imbibe material admixture on a steady basis to easily imbibe and transfer the admixture attached to first wire cylinder 18˜third wire cylinder 20 to endless felt belt 27.

In the round net depositing machine, material admixture is fed to first bath 29˜third bath 31 at specific height on a steady basis, the bottom parts of first wire cylinder 18˜third wire cylinder 20 are immersed in the admixture (slurry). In this condition, the endless felt belt 27 is driven and the depositing performs.

On the endless felt belt 27, admixture is deposited as the belt makes contact with first wire cylinder 18, second wire cylinder 19, third wire cylinder 20 one after another. In embodiment, the operation is done on the condition of depositing speed: 20 m/min˜60 m/min, pressure of making roll: 1 kgf/cm2˜5 kgc cm2.

The admixture deposited on the endless felt belt 27 is discharged in the board form between making roll 11 and bottom roll 12 and carried by the conveyor not illustrated.

Deposited substance carried by the conveyor is preserved for 6˜10 hours at normal temperature, and steam cured for 12˜24 hours at temperature ranging 60° C.˜80° C. with steam curing device. Then leave at room temperature for 100 hours for natural curing. After that, it is dried at temperature ranging 140° C.˜200 C for 5˜15 minutes in the dryer. After it is dried, it is cut processed in the specified size to be the moisture conditioning building material of 4 mm˜20 mm thick.

### EXAMPLE 1

To material mixture compound of dihydrate gypsum: 18% by weight, blast furnace slag: 40%, cement: 5%, diatomite: 20% (grain size: 30 micrometer), pulp: 5%, rock wool: 3%, and perlite (light-weight aggregate): 12%, added water and kneaded them, deposited the slurry at depositing speed: 40 m/min, pressure of making roll: 4 kgfcm2 using the aforesaid round net depositing machine, then raised the temperature to the vicinity of 70° C., steam cured at the temperature of 70° C. for 18 hours. Afterwards, natural cured for 100 hours. Then dried at 180° C. for 10 minutes in the dryer, cut processed to obtain the moisture conditioning building material (board) with thickness: 6 mm, width: 910 mm) length: 1820 mm.

### EXAMPLE 2

To material composition compound of cement: 40% by weight, rock wool: 6%. perlite: 12%, fly ash (inorganic mixture): 18%, 30 micrometergrain sized diatomite: 20%, and pulp: 4%, added water and kneaded them, deposited the slurry at depositing speed: 40 m/min using the aforesaid round net depositing machine, then raised the temperature step by step to the vicinity of 70° C., steam cured (90%RH) for 20 hours at the temperature of 70° C.

Afterwards, natural cured for 100 hours. Then dried at 180° C. for 10 minutes in the dryer, cut processed to obtain the moisture conditioning building material (board) with thickness: 6 mm, width: 910 mm, length: 1820 mm. It is the moisture conditioning building material with bending strength of 8N/mm2 level in the length direction, which has moisture absorbing/releasing ability twice as much of cedar material.

### EXAMPLE 3

To material composition compound of dihydrate gypsum: 30% by weight, slag: 30%, silica (inorganic admixture): 8%, fiberglass: 6%, 20 micrometergrain sized diatomite: 22%, and pulp: 4%, added water and kneaded: deposited the slurry at depositing speed: 40 m/min using the aforesaid round net depositing machine, then raised the temperature step by step to the vicinity of 70° C., steam cured (90%RH) for 20 hours at the temperature of 70° C.

Afterwards, natural cured for 100 hours. Then dried at 180° C. for 10 minutes in the dryer, cut processed to obtain the moisture conditioning building material (board) with thickness: 6 mm, width: 910 mm, length: 1820 mm. It is the moisture conditioning building material with bending strength of 8N/mm2 level in the length direction, which has moisture absorbing/releasing ability twice as much of cedar material.

### EXAMPLE 4

To material composition compound of asbestos: 15% by weight, cement: 51%, calcium carbonate: 10%, 27 micrometergrain sized diatomite: 20%, and pulp: 4%, add water and kneaded, deposited the slurry at depositing speed: 40 m/min using the aforesaid round net depositing machine, then raised the temperature to the vicinity of 70° C., steam cure (90%RH) for 20 hours at the temperature of 70° C. Afterwards, natural cured for 100 hours.

Then dried at 180° C. for 10 minutes in the dryer, cut processed to obtain the moisture conditioning building material (board) with thickness: 6 mm, width: 910 mm, length: 1820 mm. It is the moisture conditioning building material with bending strength of 8N/mm2 level in the length direction, which has moisture absorbing/releasing ability twice as much of cedar material.

### EXAMPLE 5

To material composition compound of asbestos: 4% by weight, rock wool 2%, slag: 30%, 18 micrometergrain sized diatomite: 28%, gypsum: 32%, and pulp: 4%, added water and kneaded them, deposited the slurry at depositing speed: 40 m/min using the aforesaid round net depositing machine, then raised the temperature step by step to the vicinity of 70° C., steam cured (90%RH) for 20 hours at the temperature of 70° C. Afterwards, natural cured for 100 hours. Then dried at 180° C. for 10 minutes in the dryer, cut processed to obtain the moisture conditioning building material (board) with thickness: 6 mm, width: 910 mm, length: 1820 mm. It is the moisture conditioning building material with bending strength of 8N/mm2 level in the length direction, which has moisture absorbing/releasing ability twice as much of cedar material.

### EXAMPLE 6

To material composition compound of lime: 40% by weight, silica rock: 30%, 35 micrometergrain sized diatomite: 20%, pulp: 4%, and rock wool: 6%, added water and kneaded them, deposited the slurry at depositing speed: 40 m/min using the aforesaid round net depositing machine, then raised the temperature step by step to the vicinity of 70° C., steam cured (90%RH) for 20 hours at the temperature of 70° C. Afterwards, natural cured for 100 hours. Then dried at 180° C. for 10 minutes in the dryer, cut processed to obtain the moisture conditioning building material (board) with thickness: 6 mm, width: 910 mm, length: 1820 mm. It is the moisture conditioning building material with bending strength of 8N/mm2 level in the length direction, which has moisture absorbing/releasing ability twice as much of cedar material.

The primary physical property of this product, the moisture conditioning building material (board) is indicated in Table 1.

TABLE 1

| | | Bending strength | | Flexural Young | |
|---|---|---|---|---|---|
| | Density | (N/mm2) | | Rate (N/mm2) | |
| Example 1 | 0.93 | L: 8 | W: 5 | L: 2083 | W: 1941 |
| Example 2 | 0.85 | L: 6 | W: 5 | L: 2063 | W: 1906 |
| Example 3 | 0.90 | L: 7 | W: 4 | L: 2015 | W: 1865 |
| Example 4 | 0.96 | L: 13 | W: 10 | L: 2565 | W: 2312 |
| Example 5 | 0.88 | L: 7.2 | W: 4.1 | L: 1980 | W: 2200 |
| Example 6 | 0.92 | L: 8.5 | W: 5.6 | L: 1850 | W: 2060 |
| Slag Gypsum | 0.96 | L: 12 | W: 8 | L: 2746 | W: 2866 |
| Board | | | | | |
| Market Goods | 0.90 | L: 9 | W: 4 | L: 2613 | W: 1657 |
| A | | | | | |
| Market Goods | 0.78 | L: 8 | W: 4 | L: 3376 | W: 1842 |
| B | | | | | |
| Gypsum | 0.68 | L: 8 | W: 3 | L: 2885 | W: 1881 |
| Board | | | | | |

As indicated in Table 1, all of Example 1˜6 of this invention, the moisture conditioning building material, bears comparison on bending strength with Market Goods A·B (Gypsum-slag-cement moisture conditioning building material). Especially Example 4, 5 were able to enhance bending strength by adding asbestos as the fiber.

Next is Table 2, which indicates moisture absorbing/releasing characteristic of this invention, the moisture conditioning building material board).

TABLE 2

| | | | | | | | Market | Market | | |
|---|---|---|---|---|---|---|---|---|---|---|
| | Example | Example | Example | Example | Example | Example | Goods | Goods | Gypsum | Cedar |
| | 1 | 2 | 3 | 4 | 5 | 6 | A | B | Board | Material |
| 1^{st} Time | | | | | | | | | | |
| Moisture Absorbing Quantity (g/m²) | 248.25 | 220.03 | 249.91 | 210.95 | 155.08 | 230.03 | 192 | 196 | 47.59 | 125.32 |
| Moisture Releasing Quantity (g/m²) | −211.79 | −181.03 | −241.1 | −160.03 | −240.06 | −219.9 | −190.4 | −161.6 | −39.54 | −94.66 |
| 2^{nd} Time | | | | | | | | | | |
| Moisture Absorbing Quantity (g/m²) | 227.42 | 175.36 | 228.97 | 151.1 | 235.99 | 185.08 | 193.6 | 179.04 | 38.85 | 109.55 |
| Moisture Releasing Quantity (g/m²) | −215.26 | −159.08 | −218.92 | −139.96 | −230.1 | −182.05 | −195.2 | −168.32 | −36.09 | −102.88 |
| 3^{rd} Time | | | | | | | | | | |
| Moisture Absorbing Quantity (g/m²) | 196.17 | 152.88 | 209.78 | 132.03 | 229.09 | 163.04 | 174.4 | 142.4 | 40.46 | 114.66 |
| Moisture Releasing Quantity (g/m²) | −192.7 | −142.65 | −200.5 | −121.01 | −218.99 | −139.95 | −169.6 | −148.16 | −38.16 | −91.55 |
| 4^{th} Time | | | | | | | | | | |
| Moisture Absorbing Quantity (g/m²) | 215.26 | 131.1 | 209.98 | 109.08 | 225.55 | 123.23 | 176 | 174.4 | 37.47 | 111.99 |
| Moisture Releasing Quantity (g/m²) | −206.58 | 125.8 | −207.76 | −100.04 | −210.56 | −119.99 | −176 | −167.04 | −37.24 | −102.43 |
| 1^{st}˜4^{th} Time | | | | | | | | | | |
| Total Moisture Absorbing/Releasing | 1713.43 | 1287.93 | 1766.87 | 1124.11 | 1845.42 | 1363.27 | 1467.2 | 1336.96 | 315.42 | 853.03 |
| Quantity | | | | | | | | | | |
| Absorbing/Releasing Rate (g/m² · Time) | 214.18 | 160.99 | 220.86 | 140.51 | 230.68 | 170.41 | 183.4 | 167.12 | 39.43 | 106.63 |
| 2^{nd}˜4^{th} Time | | | | | | | | | | |
| Total Moisture Absorbing/Releasing | 1253.39 | 886.87 | 1275.86 | 753.13 | 1350.28 | 913.34 | 1084.8 | 997.36 | 228.29 | 633.05 |
| Quantity | | | | | | | | | | |
| Absorbing/Releasing Rate (g/m² · Time) | 208.9 | 147.81 | 212.64 | 125.52 | 225.05 | 152.22 | 180.8 | 163.23 | 38.05 | 105.51 |
| 1^{st} Time | 85.31 | 82.28 | 96.47 | 75.86 | 94.11 | 95.6 | 99.17 | 82.45 | 82.09 | 75.53 |
| Moisture Releasing Rate (%) | | | | | | | | | | |
| 2^{nd} Time | 94.66 | 90.72 | 95.61 | 92.68 | 97.5 | 98.6 | 100.83 | 94.01 | 92.9 | 93.91 |
| Moisture Releasing Rate (%) | | | | | | | | | | |
| 3^{rd} Time | 98.23 | 93.81 | 95.58 | 91.65 | 95.59 | 85.84 | 97.25 | 104.05 | 94.32 | 79.85 |
| Moisture Releasing Rate (%) | | | | | | | | | | |
| 4^{th} Time | 95.97 | 95.96 | 98.97 | 91.71 | 93.35 | 97.35 | 100 | 95.78 | 99.75 | 91.47 |
| Moisture Releasing Rate (%) | | | | | | | | | | |
| Average | 93.54 | 90.56 | 96.66 | 87.98 | 95.14 | 94.29 | 99.31 | 94.07 | 92.42 | 85.19 |
| Moisture Releasing Rate (%) | | | | | | | | | | |

25 C × 65% RH, 168 hrs → 50% RH, 112 hrs → 25 C × 90% RH, 24 hrs <=>
25 C × 50% RH, 24 hrs 4 cycle.

As indicated in Table 2, Examples 1, 3, 5 of this invention, the moisture conditioning building material, had superb moisture absorbing/releasing characteristic and have absorbing/releasing amount 5 times of gypsum board, twice of cedar material.

Examples 2, 4, 6 were able to have moisture absorbing/releasing ability as or more of wood, but Examples 2, 4, which are mainly composed of cement, had tendency to decline of moisture absorbing/releasing capability.

The moisture conditioning building materials moisture absorbing dimension change in this invention is indicated in Table 3.

TABLE 3

Moisture Absorbing Dimension
Change (%)

| | | |
|---|---|---|
| Example 1 | L: 0.17 | W: 0.21 |
| Example 2 | L: 0.18 | W: 0.22 |
| Example 3 | L: 0.15 | W: 0.18 |
| Example 4 | L: 0.21 | W: 0.20 |
| Example 5 | L: 0.20 | W: 0.21 |
| Example 6 | L: 0.16 | W: 0.13 |
| Slag Gypsum | L: 0.20 | W: 0.23 |
| Board | | |
| Market Goods | L: 0.75 | W: 0.28 |
| A | | |
| Market Goods | L: 0.04 | W: 0.02 |
| B | | |
| Gypsum Board | L: 0.05 | W: 0.05 |

As indicated in Table 3, even though moisture absorbing dimensional stability in Examples 16 of this invention, moisture conditioning building material (board), were compared unfavorably with gypsum board and part of market goods B, their dimensional stability bore comparison with slag gypsum board and part of market goods A. Board's absorbing/releasing dimensional stability was enhanced by limiting addition rate of organic fiber such as pulp.

Next is Table 4, which indicates the wood screw retentivity of this invention, the moisture conditioning building material.

TABLE 4

| | Wood Screw |
|---|---|
| | Retentivity (N) |
| Example 1 | 117 |
| Example 2 | 115 |
| Example 3 | 105 |
| Example 4 | 145 |
| Example 5 | 128 |
| Example 6 | 112 |
| Slag Gypsum | 175 |
| Board | |
| Market Goods | 91 |
| A | |
| Market Goods | 105 |
| B | |
| Gypsum Board | 93 |

As indicated in Able ′4, even though wood screw retentivity in Examples 1˜6 of this invention, moisture conditioning building material (board), were compared unfavorably with slag gypsum board, they bore comparison with gypsum board and market goods A,B (Gypsum-slag-cement moisture conditioning building material). Both facts were caused because this board had higher density than gypsum board and board's. Examples 4, 5 especially had high wood screw retentivity from the addition of asbestos.

As stated previously, according to this invention, it is possible to provide moisture conditioning building material which has superb moisture absorbing/releasing characteristic, incombustibility; machinability, dimensional stability, nail wood screw retentivity, and light-weighted, at low cost.

According to the invention as described in claim 2; it can provide material with necessary characteristics which is needed as inorganic material by depositing-curing-drying.

According to the invention as described in claim 3, it can provide light weighted moisture conditioning building material which has not just superb moisture absorbing/releasing characteristic, but superb fire proofing, fire resistance, and nailing retention characteristic. Moreover, it can provide building material (board) which has uniform quality because the moisture conditioning building material in this invention is produced by the depositing method.

According to the invention as described in claim 4, it can provide pulp cement board based building material superb in conditioning moisture.

According to the invention as described in claim 5, it can provide slag gypsum board based building material superb in conditioning moisture.

According to the invention as described in claim 6, it can provide slate board based building material superb in conditioning moisture.

According to the invention as described in claim 7, it can provide fiber gypsum board based building material superb in conditioning moisture.

According to the invention as described in claim 8, it can provide silicate calcium board based building material superb in conditioning moisture.

According to the invention as described in claim 9, it can provide production method of moisture conditioning building material which produces moisture conditioning building material which has superb moisture absorbing/releasing characteristic, incombustibility, machinability, dimensional stability, nail wood screw retentivity, and light-weighted, at low cost.

According to the invention as described in claim 10, it can provide building material (board) which has uniform quality without unevenness in density because the moisture conditioning building material in this invention is produced by the depositing. method.

What is claimed is:

1. The moisture conditioning building material compound of diatomite, which contains 5%˜30% by weight in the range of grain size 2 micrometer˜100 micrometer, inorganic material and either or both of organic reinforcing fiber and inorganic fiber.

2. In the moisture conditioning building material as described in claim 1, the moisture conditioning building material characterized in that the aforesaid inorganic material is one or combination of gypsum: which gives the inorganic material fire proofing, fire resistance, form stability, form formation by depositing/curing/drying, aqua-hardening substance such as slag cement: which gives machinability, nailing retention characteristic, hardening property, and formability, and perlite: which gives light weight by its bulkyness.

3. In the moisture conditioning building material as described in claim 2, the moisture conditioning building material is comprised of dihydrate gypsum: 2%˜30% (by weight), aqua-hardening substance: 15%˜60%, perlite: 5%˜15%, either or both of organic reinforcing fiber: 3%˜5% and inorganic fiber: 1%˜8%, and is obtained by depositing method.

4. In the moisture conditioning building material as described in claim 2, the moisture conditioning building material is comprised of cement: 30%˜50% (by weight), perlite: 5%˜20%, inorganic mixture of materials: 10%˜30%, either or both of organic reinforcing fiber: 3%˜13% and inorganic fiber: 4%˜8%, and is obtained by depositing method.

5. In the moisture conditioning building material as described in claim 2, the moisture conditioning building material is comprised of dihydrate gypsum. 20%˜50% (by weight), slag: 20%˜50%, inorganic admixture: 5%˜15%, organic reinforcing fiber: 3%˜5%, inorganic fiber: 4%˜8%, and is obtained by depositing method.

6. In the moisture conditioning building material as described in claim 2, the moisture conditioning building material is comprised of asbestos: 10%˜30% by weight), cement: 30%˜70%, inorganic admixture: 8˜12%, organic reinforcing fiber: ′3%˜5%, and is obtained by depositing method.

7. In the moisture conditioning building material as described in claim 2, the moisture conditioning building material is comprised of asbestos: 2%˜6% (by weight), slag: 20%˜40%, gypsum: 20%˜60%, either or both of organic reinforcing fiber: 3%˜5% and inorganic fiber: 1%˜3%, and is obtained by depositing method.

8. In the moisture conditioning building material as described in claim 2, the moisture conditioning building material is comprised of lime: 15%˜50% (by weight), silica rock: 5%˜50%, either or both of organic reinforcing fiber: 3%˜5% and inorganic fiber: 1%˜8%, and also is obtained by depositing method.

9. The production method of the moisture conditioning building material compound of diatomite, which contains 5%˜30% by weight in the range of grain size 2 micrometer100 micrometer, inorganic material and either or both of organic reinforcing fiber and inorganic fiber, in the board formation of 4-20 mm in thickness.

10. In the production method of the moisture conditioning building material as described in claim 9, the production method of the moisture conditioning building material is characterized in that water is added to the materials to make mixed slurry, deposit to make in the thickness as prescribed, cured and dried.
